(19) United States
(12) Patent Application Publication
(10) Pub. No.: US 2021/0147166 A1
(43) Pub. Date: May 20, 2021

(54) PRINT DEVICES

(71) Applicant: Hewlett-Packard Development Company, L.P., Spring, TX (US)

(72) Inventors: Kok Chai Chong, Singapore (SG); Yi Wan, Singapore (SG); Seng San Koh, Singapore (SG)

(73) Assignee: Hewlett-Packard Development Company, L.P., Spring, TX (US)

(21) Appl. No.: 17/047,077

(22) PCT Filed: May 9, 2018
(86) PCT No.: PCT/US2018/031875

§ 371 Date: Oct. 13, 2020

(51) Int. Cl. B65H 7/04; B41J 13/10; B41J 11/58; B41J 13/00; B65H 1/14; B65H 3/32

(52) U.S. Cl. CPC B65H 7/04; B41J 13/103; B41J 11/58; B41J 13/0018; B65H 2801/03; B65H 3/32; B65H 2553/40; B65H 2553/30; B65H 2553/612; B65H 1/14

(57) ABSTRACT

A print device comprising an input tray to receive a print media stack, and a load stop arm to manage print media feed, from the input tray, into a media loading path for printing. The load stop arm is to rotate between a media stacking state and a media feed state to manage the print media feed. The load stop arm comprising a trigger protrusion to move from a default position to a trigger position when the load stop arm rotates to the media stacking state in a low stack condition. The low stack condition indicates reduction of print media in the print media stack to an amount below a threshold value. Further, a media detection assembly is in contact with the trigger protrusion to enable generation of a low media signal to indicate the low stack condition when the trigger protrusion moves to the trigger position

### BACKGROUND

Print devices are peripherals commonly used in home and office environments for obtaining printed copies of digital documents. Print devices may be provided with different print trays for handling print media during a print job. For instance, the print devices may be provided with an input print tray for holding and receiving print media of different sizes and types. The print media is typically stacked in the input tray and maybe reloaded once the print media stack gets finished. The print devices may further include an output tray for providing a printed media.

### BRIEF DESCRIPTION OF DRAWINGS

The detailed description is described with reference to the accompanying figures. It should be noted that the description and figures are merely example of the present subject matter and are not meant to represent the subject matter itself.

FIG. 1 illustrates a block diagram of a print device, according to an example of the present subject matter.

FIG. 2 illustrates a block diagram of a print media feed assembly, according to an example of the present subject matter.

FIG. 3 illustrates a block diagram of an imaging device, according to an example of the present subject matter.

FIG. 4 illustrates a block diagram of a print device, according to another example of the present subject matter.

FIG. 5 illustrates a print media feed assembly, according to an example of the present subject matter.

FIG. 6 illustrates a load stop arm and a media detection assembly of a print media feed assembly, according to an example of the present subject matter.

FIG. 7 illustrates sectional views of the load stop arm and the media detection assembly at different stages of operation, according to an example of the present subject matter.

FIG. 8 illustrates cross sectional views of the load stop arm and the media detection assembly at different stages of operation during a high stack condition, according to an example of the present subject matter.

FIG. 9 illustrates cross sectional views of the load stop arm and the media detection assembly at different stages of operation during a low stack condition, according to an example of the present subject matter.

### DETAILED DESCRIPTION

Print devices are provided with print trays, such as input trays and an output tray for handling print media during a print job. For instance, in a L-path printer, an input tray may be provided at a back of the print device, for holding and receiving print media for printing. The print device may further include an output tray in the front side of the print device for providing a printed media. In one example, the input tray may be a vertically retractable tray or a substantially vertically retractable tray housed in an input tray housing to hold the print media. The print media is typically stacked in the input tray and fed into a media loading path for printing by a gathering and kicker assembly of the print device. The gathering and kicker assembly includes a load stop arm to manage print media feed into the media loading path. To manage the print media feed, the load stop arm allows a single print medium to enter the media loading path and stacks back the remaining print media into the input tray, aligned along a predetermined edge of the input tray, for printing. Further, a media detection assembly is connected to the load stop arm and the input tray to detect an edge and size of the print medium for printing.

As the print media is consumed for printing, the print media stack reduces in size and, if not refilled, the input tray may reach an empty state. When the input tray is empty, the print device may generate a load paper signal for the user. In one example, the load paper signal may be an audio signal, such as an audible beep or a visual signal, such as an illuminated indicator or a text notification on a display screen of the print device. Print operations of a print device with an empty input tray may thus get paused until the input tray is reloaded. If a user of the print device is nearby, the user may reload the input tray to resume the printing. However, if the user is not nearby, for example, if a print command is transmitted remotely, the printing may not resume until the user reaches the print device to load the print media, thereby delaying execution of the print job. Additionally, if the input tray is not reloaded in a given time, the print job may time out and the print command may have to be sent again to the printer.

Further, in the case of a multi-purpose print devices supporting fax functionality, if a document is received by fax at a print device with an empty input tray or nearly empty tray, for example, when there is no user around the print device, for instance, at night, the print job, i.e., the fax, may time out before the input tray is reloaded. As a result, information may be lost.

The present subject matter discloses example implementations of print devices with a print media feed assembly having provisions to detect and indicate a low stack condition. The low stack condition, in one example, may indicate reduction of print media in a print media stack to an amount for example, a number, a minimum stack size, etc. below a threshold value. For example, the threshold value may be a minimum of 10% or 20% of maximum number of pages, such as 10 pages, 20 pages for a print device with an input tray having a maximum capacity of 100 pages of print media. In another example, the threshold value may be a minimum of 10% of maximum stack size, such as of 1 mm, 3 mm, etc. Further, the threshold value may vary depending upon the capacity of the input tray of the print device and type of print media being used. For instance, a print device with a high capacity of print media, for example, 500 pages may have a threshold value of 50 pages or 5 mm stack size. In another example, a print device loaded with thicker print media may have a threshold value of 15 pages or 5 mm stack size with the same tray capacity.

Further, a high stack condition may indicate that amount of the print media in the print media stack is above the threshold value. Further, a load stop arm of a print device is to rotate between a media stacking state and a media feed state to manage loading of the print media into a media loading path for printing. In one example, the media loading path may refer to a pathway through which the print media is conveyed to a print assembly for printing content on the print media.

In one example, the load stop arm may be in contact with an input tray of the print device to receive a bottom end of the print media in the print media stack, thereby, indicating to a user that the print media has been placed in the input tray. Once the print media is loaded in the input tray, the load stop arm may manage the print media feed, allowing a print medium, from the print media stack, to enter the media loading path for printing. Subsequently, the load stop arm may gather the remaining print media and push the print media into the input tray to stack and align the print media along a predetermined edge of the input tray, for a subsequent print cycle.

Further, the media stacking state may indicate a state in which the load stop arm restacks the print media in the input tray, to prepare the print media for loading into the media loading path for printing. The media feed state may indicate a state in which the load stop arm allows the print medium on top of the print media stack to be loaded into the media loading path.

In one example, a media detection assembly of the print device is in contact with the load stop arm of the print media feed assembly to enable generation of a low media signal to indicate the low stack condition when the load stop arm rotates to a media stacking state in the low stack condition. Thus, the present subject matter provides for a user notification indicating the low stack condition when the volume of print media reduces below a threshold level, thereby, alerting the user about the low stack condition.

In one example, the media detection assembly includes a sensor flag to follow the movement of the load stop arm and to enable detection of the low stack condition. In said example implementation, the sensor flag is provided with an extension arm to be in contact with the load stop arm to allow the sensor flag to follow the movement of the load stop arm in the low stack condition. For instance, as the load stop arm rotates to the media stacking state in the low stack condition, the sensor flag may follow the movement of the load stop arm and move from a first position to a second position. A sensor, for example, a media edge detection sensor, in turn, may generate a low media signal to indicate the low stack condition when the sensor flag moves to the second position. The second position of the sensor flag may refer to an arrangement of the sensor flag such that the sensor may generate the low media signal. The first position of the sensor flag may refer to an arrangement of the sensor flag such that the sensor may not generate the low media signal.

Further, the load stop arm is provided with a trigger protrusion protruding from the load stop arm, at an end in the vicinity of the media detection assembly, to be in contact with the extension arm of the sensor flag. The trigger protrusion may move from a default position to a trigger position when the load stop arm rotates to the media stacking state in the low stack condition. In one example, the default position may correspond to the high stack condition of the print media stack, such that the sensor flag remains in the first position. As used herein, the trigger position may correspond to a low stack condition of the print media stack, such as to move the sensor flag from the first position to the second position. Thus, as the trigger protrusion moves to the trigger position, the sensor flag may move to the second position enabling the sensor to generate the low media signal.

The present subject matter, may thus enable alerting users about low stack conditions, thereby allowing the users to timely reload the print media. As low stack conditions can be identified in advance, print jobs may be scheduled accordingly, such as to avoid initiating print jobs with insufficient amounts of print media. For instance, a second input tray may be used in print devices having more than one input tray, the print device may provide a low media message to a client device in response to reception of a print job, and/or the print media may be reloaded before initiating the print job.

Further, an example print device may also use a similar sensor in its media detection assembly, such as an edge detection sensor. It may be possible to use the claimed load stop arm and sensor flag, without other alterations to the example print device. As such, costs to update the media feed assembly may remain minimal.

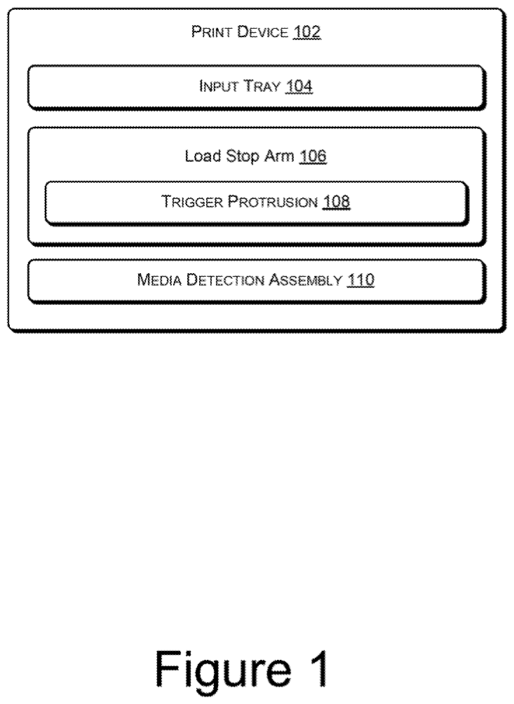

The present subject matter is further described with reference to FIGS. 1 to 8. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a block diagram of a print device 102, according to an example implementation of the present subject matter. The print device 102 may be used for printing documents on a print medium, such as paper. Examples of the print device 102 include, but are not limited to, a printer, a multifunction printer, a home printer, and an office printer. In accordance to an example implementation of the present subject matter, the print device 102 includes an input tray 104 to receive a print media stack for printing. The print device 102 further includes a load stop arm 106 to manage print media feed, from the input tray 104, into a media loading path for printing. In one example, the load stop arm 106 is to rotate between a media stacking state and a media feed state to manage the print media feed. In one example, the load stop arm 106 may manage the print media feed, allowing a print medium, from the print media stack, to enter the media loading path for printing. For instance, in a media feed state, the load stop arm 106 may allow a print medium to enter the media loading path. In a media stacking state, the load stop arm 106 may constrain movement of a stack of print media, such as by keeping print media from entering the media loading path of the print device 102. Further, the media loading path may refer to a pathway through which the print media is conveyed to a print assembly of the print device 102 for printing content on the print media.

In one example, the load stop arm 106 includes a trigger protrusion 108 to move between a default position and a trigger position based on an amount, for example, a number, a minimum stack size, etc., of the print media in the print media stack. In one example, the default position may be a position corresponding to a high stack condition, in which the amount of the print media in the print media stack is above a threshold value. Further, the trigger position may be a position corresponding to the media stacking state during a low stack condition of the print media stack, in which the amount of the print media in the print media stack is below the threshold value.

In one example, the trigger protrusion 108 may move from the default position to the trigger position when the load stop arm 106 rotates to the media stacking state in a low stack condition. In one example, a low stack condition indicates reduction of print media in the print media stack to an amount below a threshold value. Further, the trigger protrusion 108 may remain in the default position when the load stop arm 106 rotates to the media stacking state when the low stack condition is not reached.

The print device 102 further includes a media detection assembly 110 in contact with the trigger protrusion 108 to enable generation of a low media signal to indicate the low stack condition when the trigger protrusion 108 moves to the trigger position, thereby informing a user about low media stack.

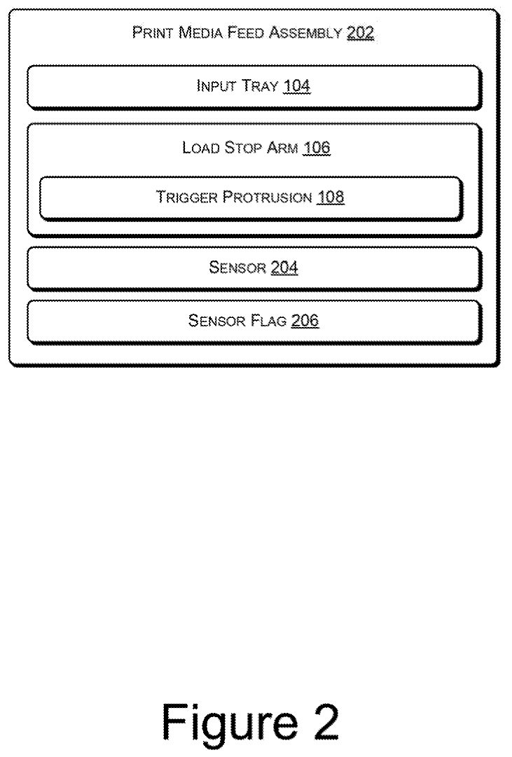

FIG. 2 illustrates a block diagram of a print media feed assembly 202, according to an example implementation of the present subject matter. In accordance to an example implementation of the present subject matter, the print media feed assembly 202 may be implemented in printing and scanning device, such as a print device and an imaging device. The print media feed assembly 202 includes the input tray 104, the load stop arm 106 having the trigger protrusion 108, a sensor 204, and a sensor flag 206.

The input tray 104 is to receive the print media stack for printing. Further, the load stop arm 106 may manage print media feed from the input tray 104, into a media loading path for printing such that the load stop arm 106 is to rotate between the media stacking state and the media feed state to manage the print media feed. The load stop arm 106 may further include the trigger protrusion 108. In one example, the trigger protrusion 108 may move from the default position to the trigger position when the load stop arm 106 rotates to the media stacking state in the low stack condition.

Further, sensor flag 206 may include an extension arm in contact with the trigger protrusion 108 such that the sensor flag 206 may move from a first position to a second position when the trigger protrusion 108 moves to the trigger position. In one example, the sensor 204 may enable generation of a low media signal to indicate the low stack condition when the sensor flag 206 moves to the second position.

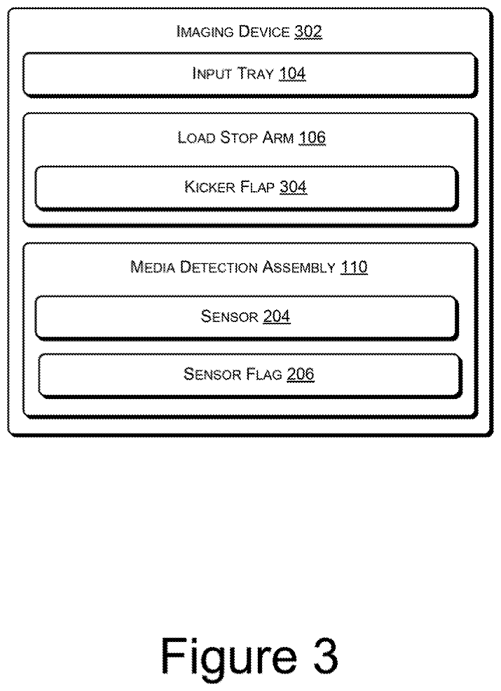

FIG. 3 illustrates a block diagram of an imaging device 302, according to an example implementation of the present subject matter. Examples of the imaging device include, but are not limited to, printers, multi-functional printers, scanners, etc. In one example, the imaging device 302 includes an input tray, such as the input tray 104 to receive a print media stack for printing. The imaging device 302 may further include a load stop arm, such as the load stop arm 106 to manage print media feed, from the input tray 104, into the media loading path for printing.

The load stop arm 106 may further include a kicker flap 304 protruding from the load stop arm 106 to align print media stack in a loading position in the input tray 104. In one example, kicker flap 304 may swing from the media stacking state to the media feed state to allow a print medium, from the print media stack, to be loaded into the media loading path. Further, the kicker flap 304 may swing back to the media stacking state, upon loading of the print medium, to stack remaining print media in the loading position.

The imaging device 302 may further include the media detection assembly 110, in contact with the load stop arm 106. The media detection assembly 110 may further include the sensor flag 206 having an extension arm in contact with the load stop arm 106. In one example, the sensor flag 206 may move from a first position to a second position when the kicker flap 304 rotates to the media stacking state in the low stack condition. Further, the sensor 204 of the media detection assembly 110 may generate a low media signal to indicate the low stack condition as the sensor flag 206 moves to the second position.

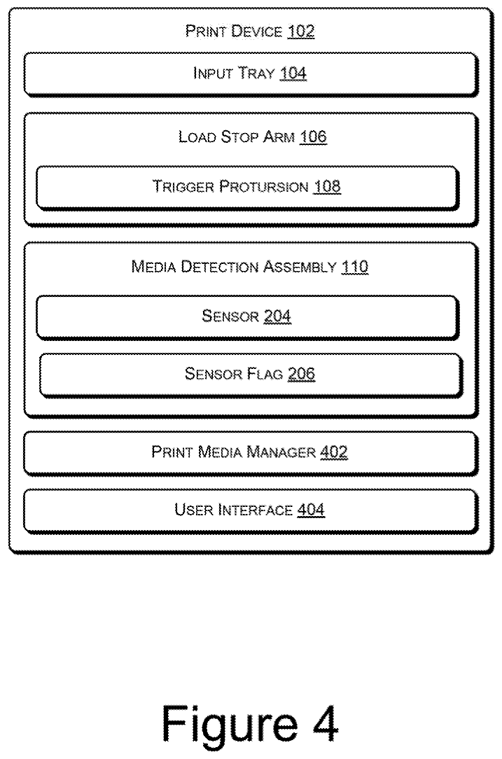

FIG. 4 illustrates a block diagram of the print device 102, according to another example of the present subject matter. As previously described, the print device 102 may include the input tray 104, the load stop arm 106 having the trigger protrusion 108, and the media detection assembly 110 having the sensor 204 and the sensor flag 206. In one example, the load stop arm 106 is to rotate between the media stacking state and the media feed state to manage loading of the print media into the media loading path for printing. Further, the sensor flag 206 of the media detection assembly 110 is in contact with trigger protrusion 108 of the load stop arm 106 such that the sensor flag 206 may move from the first position to the second position when the trigger protrusion 108 moves to the trigger position. The sensor 204, in turn, may generate a low media signal to indicate the low stack condition.

In one example implementation, the sensor 204 may be communicatively coupled to a print media manager 402 to generate a user notification indicating low media stack based on the low media signal received from the sensor 204. In one example, the print media manager 402 may display the user notification on a user interface 404 of the print device 102. In another example, the print media manager 402 may display the user notification on a user device connected to the print device 102. Thus, the present subject matter provides a user notification indicating the low stack condition when the amount of print media reduces below a threshold level.

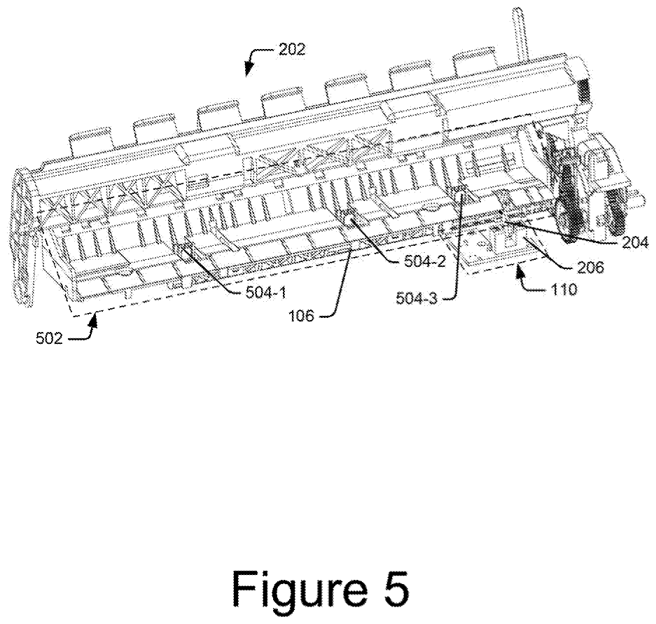

FIG. 5 illustrates the print media feed assembly 202, according to an example of the present subject matter. The print media feed assembly 202 may be implemented in a print device, such as the print device 102 or an imaging device, such as the imaging device 302. In one example, the print media feed assembly 202 may manage print media stack in the input tray 104 and print media feed into the media loading path for printing. The print media feed assembly 202 may include a gathering and kicker assembly 502 for loading the print media into the media loading path. The print media feed assembly 202 may further include the media detection assembly 110 to detect an edge and size of the print medium for printing and to detect the low stack condition of the print media stack. As previously described, a low stack condition indicates reduction of print media in the print media stack to an amount below a threshold value. Further, a high stack condition may indicate that amount of the print media in the print media stack is above the threshold value. In one example, the threshold value may be a minimum of 10% or 20% of maximum number of pages, such as 10 pages, 20 pages for a print device with an input tray having a maximum capacity of 100 pages of print media. In another example, the threshold value may be a minimum of 10% of maximum stack site, such as of 1 mm, 3 mm, etc. Further, the threshold value may vary depending upon the capacity of the input tray of the print device and type of print media being used. For instance, a print device with a high capacity of print media, for example, 500 pages may have a threshold value of 50 pages or 5 mm stack size. In another example, a print device loaded with thicker print media may have a threshold value of 15 pages or 5 mm stack size with the same tray capacity. In one example, the threshold value may be user defined. In another example, the threshold value may be preset by a manufacturer of the print device 102.

In one example implementation of the present subject matter, the gathering and kicker assembly 502 includes the load stop arm 106 to allow a single print medium to enter the media loading path from the input tray 104. Further, the load stop arm 106 includes a kicker flap 304, protruding from the load stop arm 106, to hold the print media stack in the in the input tray 104 and to allow the print medium to enter the media loading path from the input tray 104. In one example, the load stop arm 106 may include more than one kicker flaps. For instance, the load stop arm of a L-path printer may include three kicker flaps 504-1, 504-2, and 504-3, as illustrated. The kicker flaps 504-1, 504-2, and 504-3 are hereinafter individually referred to as kicker flap 304 and collectively as kicker flaps 304.

In said example, the load stop arm 106 rotates between a media stacking state and a media feed state to manage print media feed from the input tray 104 to the media loading path. The media stacking state may indicate a state in which the kicker flaps 304 are contact with a print medium placed at top of the print media stack in the input tray 104. In the media stacking state, the load stop arm 106 and the kicker flap 304 maintain the print media in a loading position in the input tray 104, aligned along a predetermined edge of the input tray 104, for printing. As the print device 102 initiates a print job, the load stop arm 106 and the kicker flap 304 swing to the media feed state to allow the print medium on top of the print media stack to be loaded into the media loading path.

As the print medium is loaded into the media loading path for printing, the load stop arm 106 and the kicker flap 304 swing back to the media stacking state to restack and align the remaining print media in the loading position in the input tray 104. The kicker flap 304 may then come in contact with a new print medium now placed at the top of the print media stack.

As previously described, the load stop arm 106 further comprises the trigger protrusion 108 to move from a default position to a trigger position when the load stop arm 106 rotates to the media stacking state in the low stack condition, owing to a large degree of rotation of the load stop arm. Further, the trigger protrusion 108 may remain in the default position when the load stop arm 106 rotates to the media stacking state in the high stack condition, owing to a smaller degree of rotation of the load stop arm. The structure and functioning of the trigger protrusion 108 and the relation between the movement of the trigger protrusion 108 and the load stop arm 106 is further illustrated and described in FIGS. 5 to 8.

In one example, the media detection assembly 110 is in contact with the load stop arm 106 to detect low stack condition. As previously described, the media detection assembly 110 includes the sensor 204 and the sensor flag 206. The sensor flag 206 is in contact with the trigger protrusion 108 such that the sensor flag 206 may move from a first position to a second position when the trigger protrusion 108 to the trigger position. Further, the sensor 204 may generate a low media signal to indicate the low stack condition when the sensor flag 206 moves to the second position. In one example, the sensor 204 may be an optical sensor. In another example, the sensor 204 may be an ultrasonic sensor. Further, the print media manager 402 may generate the user notification indicating low media stack based on the low media signal received from the sensor 204.

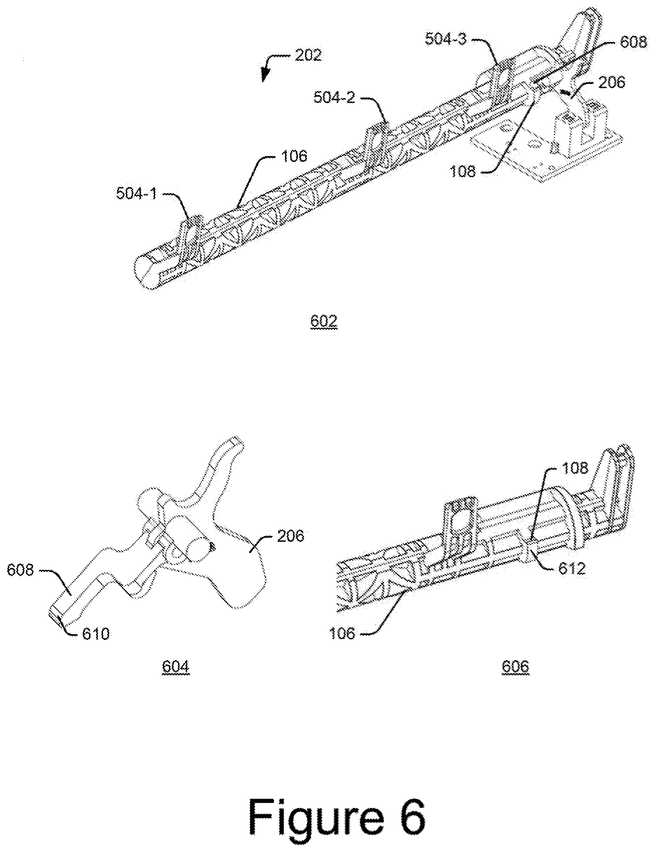

FIG. 6 illustrates the load stop arm 106 and the media detection assembly 110 of the print media feed assembly 202, according to an example of the present subject matter. A perspective view 602 illustrates the load stop arm 106 and the sensor flag 206 in contact with the trigger protrusion 108 of the load stop arm 106. Enlarged views 604 and 606 illustrate the sensor flag 206 and the trigger protrusion 108, respectively.

As illustrated, in the perspective view 602 and the enlarged view 604, the sensor flag 206 includes an extension arm 608 to be in contact with the trigger protrusion 108 of the load stop arm 106. In one example, the extension arm 608 and the trigger protrusion 108 are designed to have complimentary profiles so that the sensor flag 206 and the trigger protrusion 108 may be in contact while the load stop arm 106 rotates at the low stack condition. Further, a free end 610 of the extension arm 608 rests on a top end 612 of the trigger protrusion 108. As illustrated in the enlarged view 606, the top end 612 of the trigger protrusion 108 is slightly raised to receive the free end 610 of the extension arm 608. In one example, the sensor flag 206 may be an existing sensor flag provided with the extension arm 608. Further, the trigger protrusion 108 may be provided on an existing load stop arm to obtain the load stop arm 106.

In one example, the trigger protrusion 108 is provided such that the degree of rotation of the trigger protrusion 108 may vary depending on a stack size of the print media stack. For instance, in the high stack condition the trigger protrusion 108 may have a small degree of rotation and the trigger protrusion 108 may remain in a default position. Further, due to the small degree of rotation of the trigger protrusion 108, the sensor flag 206 too may not move from its position and remain in the first position, thereby concealing the sensor 204 of the media detection assembly 110. However, as an amount of print media in the input tray decreases, the degree of rotation of the load stop arm 106 and the trigger protrusion 108 may start to increase such that in a low stack condition, the trigger protrusion 108 may move to the trigger position. As the trigger protrusion 108 rotates to the trigger position, the sensor flag 206 may rotate by a higher degree of rotation, to the second position, thereby triggering the sensor 204 to generate the low media signal.

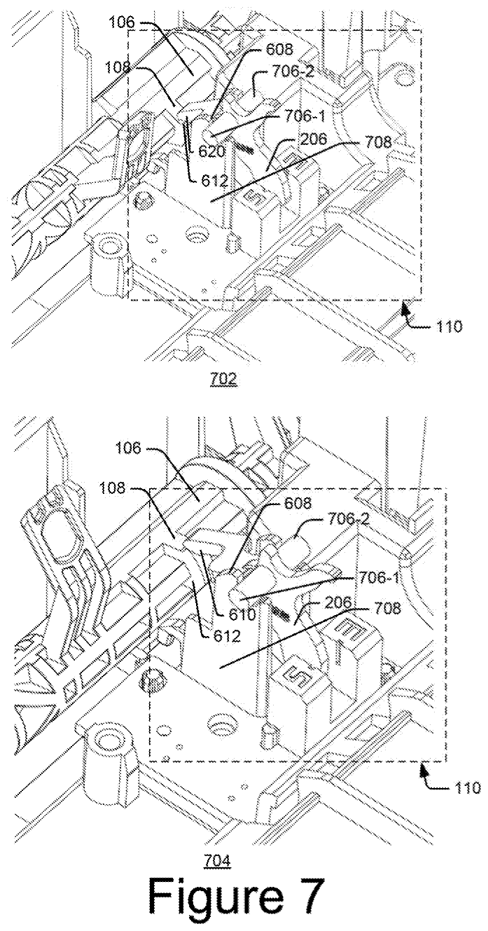

FIG. 7 illustrates sectional views 702 and 704 of the load stop arm 106 and the media detection assembly 110 at different stages of operation, according to an example of the present subject matter. The sectional view 702 illustrates the load stop arm 106 and the media detection assembly 110 in an idle position, i.e., when the trigger protrusion 108 is in the default position, for instance, when the print device 102 is in the high stack condition or is not printing. As illustrated, the default position of the trigger protrusion 108 may correspond to the first position of the sensor flag 206, such that the sensor 204 is triggered to generate the low media signal. In one example, the trigger protrusion 108 may be referred to be in the default position at all instances apart from the instance in which the trigger protrusion 108 is at the trigger position, i.e., when the sensor flag 206 is at the second position.

The sectional view 704 illustrates the load stop arm 106 and the media detection assembly 110 in the low stack condition. As illustrated, the trigger protrusion 108 moves upwards, to the trigger position in the low stack condition, thereby, laterally pushing the extension arm 608 in the upright direction. The lateral movement of the extension arm 608, makes the sensor flag 206 rotate to the second position, thereby triggering the sensor 204 to generate the low media signal. In one example, the sensor flag 206 may include rollers 706-1 and 706-2 to allow the sensor flag 206 to rotate along a stand 708 holding the sensor flag 206.

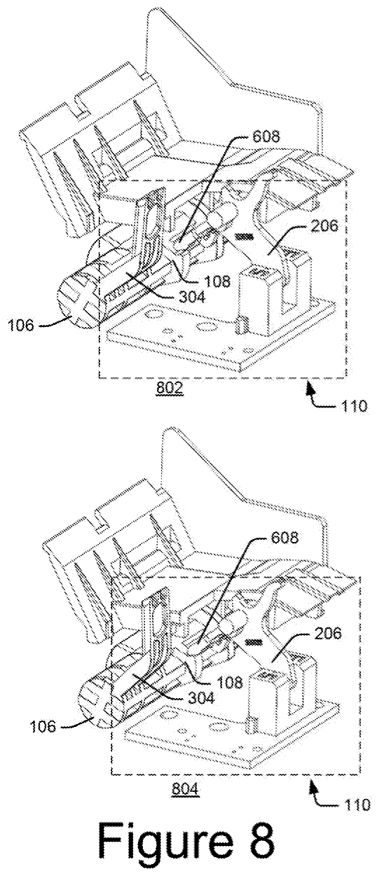

FIG. 8 illustrates cross sectional views of the load stop arm 106 and the media detection assembly 110 at different stages of operation during the high stack condition, according to an example of the present subject matter. A first view 802 illustrates the load stop arm 106 and the media detection assembly 110 in the media feed state during the high stack condition. A second view 804 illustrates the load stop arm 106 and the media detection assembly 110 in the media stacking state during the high stack condition.

As illustrated in the FIG. 8, during the high stack condition, when the load stop arm 106 moves from the media feed state to the media stacking state, the kicker flap 304 may swing by a small degree to gather and restack the print media stack. Owing to the small degree of swing of the kicker flap 304, the trigger protrusion 108 may rotate by a small degree of rotation and remain in the default position. The sensor flag 206, in turn, may not move and remain in the first position, thereby concealing the sensor 204 of the media detection assembly 110.

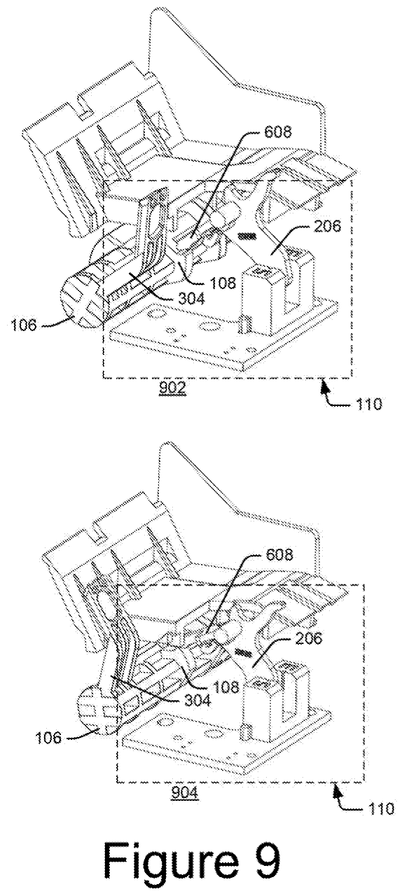

FIG. 9 illustrates cross sectional views of the load stop arm 106 and the media detection assembly 110 at different stages of operation during the high stack condition, according to an example of the present subject matter. A first view 902 illustrates the load stop arm 106 and the media detection assembly 110 in the media feed state during the low stack condition. A second view 904 illustrates the load stop arm 106 and the media detection assembly 110 in the media stacking state during the low stack condition.

As illustrated in the FIG. 9, during the low stack condition, when the load stop arm 106 moves from the media feed state to the media stacking state, the kicker flap 304 may swing by a high degree to get in touch with the print media stack. Owing to the long swing of the kicker flap 304, the trigger protrusion 108 may rotate by a large degree of rotation and move to the trigger position. Further, the trigger protrusion 108 may move the sensor flag 206 from the first position to the second position. The sensor 204 in turn may generate the low media signal to indicate the low stack condition.

Although examples for the present subject matter have been described in language specific to structural features and/or methods, it should be understood that the appended claims are not limited to the specific features or methods described. Rather, the specific features and methods are disclosed and explained as examples of the present subject matter.

I/We claim:

1. A print device comprising:
an input tray to receive a print media stack for printing, wherein a low stack condition indicates reduction of print media in the print media stack to an amount below a threshold value;
a load stop arm to manage print media feed, from the input tray, into a media loading path for printing, wherein the load stop arm is to rotate between a media stacking state and a media feed state to manage the print media feed, the load stop arm comprising:
a trigger protrusion to move from a default position to a trigger position when the load stop arm rotates to the media stacking state in the to stack condition; and
a media detection assembly in contact with the trigger protrusion to enable generation of a low media signal to indicate the low stack condition when the trigger protrusion moves to the trigger position.

2. The print device as claimed in claim 1, wherein the load stop arm further comprises a kicker flap protruding from the load stop arm to align print media stack in a loading position in the input tray, wherein in the media stacking state, the kicker flap is in contact with a print medium placed at top of the print media stack.

3. The print device as claimed in claim 2, wherein the kicker flap is to swing from the media stacking state to the media feed state to allow the print medium to be loaded into the media loading path, and wherein the kicker flap is to swing back to the media stacking state, upon loading of the print medium, to be in contact with a new print medium now placed at top of the print media stack, to stack remaining print media in the loading position.

4. The print device as claimed in claim 1, wherein the media detection assembly further comprises:
a sensor flag having an extension arm in contact with the trigger protrusion, wherein the sensor flag is to move from a first position to a second position when the trigger protrusion moves to the trigger position; and
a sensor to generate the low media signal to indicate the low stack condition when the sensor flag moves to the second position.

5. The print device as claimed in claim 4, wherein the sensor is one of an optical sensor or an ultrasonic sensor.

6. The print device as claimed in claim 1, further comprising a print media manager to generate a user notification indicating low media stack based on the low media signal received from the media detection assembly.

7. The print device as claimed in claim 6, wherein the print media manager is to display the user notification indicating low media stack on a user interface of the print device.

8. A print media feed assembly comprising:
an input tray to receive a print media stack for printing, wherein a low stack condition indicates reduction of print media in the print media stack to an amount below a threshold value;
a load stop arm to manage print media feed, the input tray, into a media loading path for printing, wherein the load stop arm is to rotate between a media stacking state and a media feed state to manage the print media feed, the load stop arm comprising:
a trigger protrusion to move from a default position to a trigger position when the load stop arm rotates to the media stacking state in the low stack condition;
a sensor flag having an extension arm in contact with the trigger protrusion, wherein the sensor flag is to move from a first position to a second position when the trigger protrusion moves to the trigger position; and
a sensor to generate a low media signal to indicate the low stack condition when the sensor flag moves to the second position.

9. The print media feed assembly as claimed in claim 8, wherein the load stop arm further comprises a kicker flap protruding from the load stop arm to align print media stack in a loading position in the input tray, wherein in the media stacking state, the kicker flap is in contact with a print medium placed at top of the print media stack.

10. The print media feed assembly as claimed in claim 9, wherein the kicker flap is to swing from the media stacking state to the media feed state to allow the print medium to be loaded into the media loading path, and wherein the kicker flap is to swing back to the media stacking state, upon loading of the print medium, to be in contact with a new print medium now placed at top of the print media stack, to stack remaining print media in the loading position.

11. The print media feed assembly as claimed in claim 8, wherein the trigger protrusion and the extension arm of the sensor flag have complimentary profiles to allow the trigger protrusion to move the sensor flag from the first position to the second position.

12. An imaging device comprising:
an input tray to receive a print media stack for printing, wherein a low stack condition indicates reduction of print media in the print media stack to an amount below a threshold value:
a load stop arm to manage print media feed, from the input tray, into a media loading path for printing, the load stop arm comprising:
a kicker flap protruding from the load stop arm to align print media stack in a loading position in the input tray, wherein the kicker flap is to swing from a media stacking state to a media feed state to allow a print medium, from the print media stack, to be loaded into the media loading path, and wherein the kicker flap is to swing back to the media stacking state, upon loading of the print medium, to stack remaining print media in the loading position; and
a media detection assembly in contact with the load stop arm, the media detection assembly comprising:
a sensor flag having an extension arm in contact with the load stop arm, wherein the sensor flag is to move from a first position to a second position when the kicker flap rotates to the media stacking state in the low stack condition; and
a sensor to generate a low media signal to indicate the low stack condition when the sensor flag moves to the second position.

13. The imaging device as claimed in claim 12, wherein the load stop arm further comprises a trigger protrusion to move from a default position to a trigger position when the load stop arm rotates to the media stacking state in the low stack condition.

14. The imaging device as claimed in claim 13, wherein the sensor flag is in contact with the trigger protrusion, and wherein the trigger protrusion and the extension arm of the sensor flag have complimentary profiles to allow the trigger protrusion to move the sensor flag from the first position to the second position.

15. The imaging device as claimed in claim 12, wherein in the media stacking state, the kicker flap is in contact with the print medium placed at top of the print media stack.
